(19) United States
(12) Patent Application Publication
(10) Pub. No.: US 2017/0024830 A1
(43) Pub. Date: Jan. 26, 2017

(54) ENHANCED EMPLOYEE TURNOVER RATE

(71) Applicant: Linkedln Corporation, Mountain View, CA (US)

(72) Inventors: Yi Feng, Sunnyvale, CA (US); Weizhen Wang, San Jose, CA (US); Dong Li, Sunnyvale, CA (US)

(21) Appl. No.: 14/804,127

(22) Filed: Jul. 20, 2015

(51) Int. Cl. G06Q 50/00; G06Q 10/10

(52) U.S. Cl. CPC G06Q 50/01; G06Q 10/105

(57) ABSTRACT

Disclosed in some examples are methods, systems, and machine readable mediums for providing an enhanced employee turnover rate (EETR). The EETR factors in seniority level in the turnover rate calculation without introducing direct weightings. To avoid bias issues, a formula is created based upon the observation that seniority and numerosity are inverse. That is, there are fewer senior level positions than there are entry level positions in most companies. In some examples, the EETR may be calculated automatically using social networking service data that is maintained by the social networking service and updated by the employees themselves. This relieves the organization of the task of manually calculating this data.

### BACKGROUND

A social networking service is a computer or web-based service that enables users to establish links or connections with persons for the purpose of sharing information with one another. Some social network services aim to enable friends and family to communicate and share with one another, while others are specifically directed to business users with a goal of facilitating the establishment of professional networks and the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a flowchart of a method of calculating an enhanced employee turnover rate (EETR) according to some examples of the present disclosure.

FIG. 2 is a flowchart of example methods of collecting EETR metrics and calculating the components of the EETR according to some examples of the present disclosure.

FIG. 3 is a schematic of a social networking service according to some examples of the present disclosure.

FIG. 4 is a block diagram illustrating an example of a machine upon which one or more embodiments may be implemented.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business networking service. The present inventive subject matter is generally applicable to a wide range of information and networked services as well as other types of social networking services. For example, online job boards where users can view or post resumes and employers can post job openings.

A social networking service is a type of networked service provided by one or more computer systems accessible over a network that allows members of the service to build or reflect social networks or social relations among members. Members may be individuals or organizations. Typically, members construct profiles, which may include personal information such as the member's name, contact information, employment information, photographs, personal messages, status information, multimedia, links to web-related content, blogs, and so on. In order to build or reflect the social networks or social relations among members, the social networking service allows members to identify, and establish links or connections with other members. For instance, in the context of a business networking service (a type of social networking service), a member may establish a link or connection with his or her business contacts, including work colleagues, clients, customers, personal contacts, and so on. With a social networking service, a member may establish links or connections with his or her friends, family, or business contacts. While a social networking service and a business networking service may be generally described in terms of typical use cases (e.g., for personal and business networking respectively), it will be understood by one of ordinary skill in the art with the benefit of Applicant's disclosure that a business networking service may be used for personal purposes (e.g., connecting with friends, classmates, former classmates, and the like) as well as, or instead of, business networking purposes; and a social networking service may likewise be used for business networking purposes as well as or in place of social networking purposes. A connection may be formed using an invitation process in which one member “invites” a second member to form a link. The second member then has the option of accepting or declining the invitation.

In general, a connection or link represents or otherwise corresponds to an information access privilege, such that a first member who has established a connection with a second member is, via the establishment of that connection, authorizing the second member to view or access certain non-publicly available portions of their profiles that may include communications they have authored. Example communications may include blog posts, messages, “wall” postings, or the like. Of course, depending on the particular implementation of the business/social networking service, the nature and type of the information that may be shared, as well as the granularity with which the access privileges may be defined to protect certain types of data may vary.

Some social networking services may offer a subscription or “following” process to create a connection instead of, or in addition to the invitation process. A subscription or following model is where one member “follows” another member without the need for mutual agreement. Typically in this model, the follower is notified of public messages and other communications posted by the member that is followed. An example social networking service that follows this model is Twitter®—a micro-blogging service that allows members to follow other members without explicit permission. Other connection-based social networking services also may allow following-type relationships as well. For example, the social networking service LinkedIn® allows members to follow particular companies.

In some examples, organizations such as companies may be part of the social networking service. Organizations can create profile pages and can establish connections much the same way members can. The social networking service may also assist the organizations in attracting and retaining employees. For example, the social networking service may allow organizations to post open job positions. Members of the social networking service may then apply for the position through the social networking service. This process is facilitated through one or more graphical user interfaces provided by the social networking service.

Attracting and retaining great employees is a difficult problem facing many companies. Tools such as those provided by the social networking service to help organizations attract and fill open positions help, however these tools do not assist organizations in keeping the talent they already have.

Human resources departments monitor a metric called “employee turnover rate,” which monitors performance in retaining employees. Employee turnover may be a symptom of issues in a company including low morale, absence of a clear career path, lack of recognition, poor employee-manager relationships or other issues. Monitoring the employee turnover rate can help managers stay ahead of these potential problems and take corrective action to reduce turnover. The traditional turnover rate calculation is:

$$( \frac{NELDY}{( NEBY + NEEY ) \text{/} 2} ) * 100$$

### Where:

NELDY=the number of employees who left during the year;

NEBY=the number of employees at the beginning of the year;

NEEY=the number of employees at the end of the year;

The problem with the formula above is that it assumes that the negative impact to the organization resulting from each employee that leaves is equal. For example, the above formula assumes that a skilled employee leaving impacts the organization as much as a non-skilled employee. In reality, a more senior employee leaving generally will cause more disruption to an organization than a junior level employee leaving.

One method for improving the turnover rate calculation would be to factor in the seniority level of employees. In this method, turnover in more senior positions causes a greater impact on the overall turnover rate than turnover in less senior positions. This may be accomplished by grouping employees by seniority and calculating separate employee turnover rates for each group. Each seniority level's turnover rate may be weighted and combined (e.g., summed) to form a combined turnover rate. This method may be problematic in that biases may be introduced when selecting the weights for each employee group. Therefore, what is needed is a way to factor in employee seniority without introducing a bias in the weighting function to produce an enhanced employee turnover rate.

In addition to potentially introducing biases, an improved employee turnover rate that factors in employee seniority requires much more effort in tracking employee turnover as the organization's employees have to manually track and calculate the data needed to calculate the employee turnover rate, including establishing and tracking seniority levels.

Disclosed in some examples are methods, systems, and machine readable mediums for providing an enhanced employee turnover rate (EETR). The EETR factors in seniority level in the turnover rate calculation without introducing direct weightings. To avoid bias issues, a formula is created based upon the observation that seniority and numerosity are inverse. That is, there are fewer senior level positions than there are entry level positions in most companies. In some examples, the EETR may be calculated automatically using social networking service data that is maintained by the social networking service and updated by the employees themselves. This relieves the organization of the task of manually calculating this data.

Using the insight that seniority and numerosity are inverse, an EETR for a given time period may be defined as:

$$EETR = \frac{{\sum }_{i = 1}^{n} ( ln ( \frac{N}{{A}_{i}} ) * \frac{{S}_{i}}{{A}_{i}} )}{{\sum }_{i = 1}^{n} ln ( \frac{N}{{A}_{i}} )}$$

### Where:

n is the number of seniority levels. One example group of seniority levels is: Chief Executive Officer level, VP level, Director level, Manager level, Senior level, and Entry level. In this example, n=6. n=1 denotes Entry level, n=2 is Senior level, n=3 is Manager level, n=4 is Director level, n=5 is Vice President level, and n=6 is Chief Officer level (e.g., CEO, CTO, CFO, COO).
N is the average number of all employees for the given time period (for all levels). For example, if the time period is a month, and on February 1^{st}, there are 1000 total employees, and on February 28^{th} there are 1200, then the average is (1000+1200)/2=1100.
Aᵢ is the average number of employees for the ith seniority level in the same time period. For example, if the time period is a month, and on February 1^{st} there are 500 employees in Entry level positions, and on February 28^{th} there are 550 then A₁=(550+500)/2=525.
Sᵢ is the total number of employees that left in that time period for that seniority level.
The given time period over which the EETR is calculated is either predetermined or is set by a user. Example time periods include a week, a month, a quarter, a half year, a year, and the like.

The range for EETR is [0, 2] in which 0 is the minimum (nobody has left the company during the time period) to a maximum of 2 (everybody at the company has left).

To see how this works, consider the following examples:

### Example 1

One employee from each level leaves during the period.

n=3 (three seniority levels, Executive level, Mid level, and Entry level)

| | | | Aᵢ = (End − | Sᵢ = (Start − |
|---|---|---|---|---|
| | Start | End | Start)/2 | End) |
| Entry | 1000 | 999 | 999.5 | 1 |
| Mid | 100 | 99 | 99.5 | 1 |
| Executive | 6 | 5 | 5.5 | 1 |

In this case, N=(1000+100+6+999+99+5)/2=1104.5. The EETR is equal to 0.126563.

### Example 2

Same as Example 1, but with an additional entry level employee leaving:

| | | | Aᵢ = (End − | Sᵢ = (Start − |
|---|---|---|---|---|
| | Start | End | Start)/2 | End) |
| Entry | 1000 | 998 | 999 | 2 |
| Mid | 100 | 99 | 99.5 | 1 |
| Executive | 6 | 5 | 5.5 | 1 |

In this case, N=1104 and the EETR comes out to be 0.126578. The employee turnover rate increased by only 1.5×10⁻⁵ over the previous example.

### Example 3

Now consider the original case illustrated in Example 1, but with an additional mid-level person leaving:

| | | | Aᵢ = (End − | Sᵢ = (Start − |
|---|---|---|---|---|
| | Start | End | Start)/2 | End) |
| Entry | 1000 | 999 | 999.5 | 1 |
| Mid | 100 | 98 | 99 | 2 |
| Executive | 6 | 5 | 5.5 | 1 |

In this case, N=1104 and the EETR comes out to be 0.129632. The employee turnover rate increased from Example 1 by 0.00307=(3.07×10⁻³), which is more than the increase over example 1 in example 2. This demonstrates that the EETR increases more for Mid level turnover than Entry level turnover.

### Example 4

Now consider the original case illustrated in Example 1, but with an additional executive level person leaving:

| | | | Aᵢ = (End − | Sᵢ = (Start − |
|---|---|---|---|---|
| | Start | End | Start)/2 | End) |
| Entry | 1000 | 999 | 999.5 | 1 |
| Mid | 100 | 99 | 99.5 | 1 |
| Executive | 6 | 4 | 5 | 2 |

Again, N=1104 and the EETR is 0.27624 which represents an increase over Example 1 of 0.14968.

As can be appreciated from the above examples, the loss of the extra executive level employee had a significantly greater impact on the EETR than either the loss of the Mid level or Entry level employee. For comparison, the traditional turnover rate calculation would be 0.362319% regardless of the seniority level of the employee that left.

In some examples, the EETR may be provided to companies that are members of a social networking service. The EETR may be provided as part of a graphical user interface to an administrator of the company. In other examples, the EETR may be provided on the company's profile page. In still other examples, the EETR may be provided to one or more job seekers as they view a job posting from the company. In yet further examples, the social networking service may provide the EETR of one company to another company as part of a competitive intelligence report. Companies may be ranked by EETR and this ranking may be provided to one or more members. In some examples, the ranking is relative to other companies in the same industry.

Other example applications of the EETR may be to determine patterns of turnover. For example, during certain seasons turnover may be higher at certain companies. These results may be presented to companies—either the company at which the pattern is observed, rival companies (e.g., as part of a competitive intelligence report), or recruiters. In some examples, these trends or patterns may be provided to one or more recruiters through one or more recruiting platforms provided by the social networking service. For example, the social networking service may provide a recruiter a list of companies and times those companies tend to experience higher turnover in order to provide additional leads for the recruiter (who may focus their recruitment on employees from those companies at those times). Additionally, the EETR may be provided on a per-seniority level basis. Thus recruiters will know which seniority levels to recruit from which company at the appropriate time.

Other example uses of EETR include providing the EETR as part of a report prepared for investors. The EETR may be utilized to analyze a company′ organizational structure trend in order to predict its future operational performance. A high EETR rate normally indicates that the company is unstable, which might lead to a worse quarterly/annually outcome. In other examples, the EETR may be utilized by business analysts to setup industrial benchmarks to measure the performance of an individual company or cross reference different industries or even in a larger scale, same industry in different countries. In still other examples, the EETR may be aggregated across one or more groups of companies. This aggregated EETR may be utilized by policy makers as a reference of domestic/regional economic stability. EETR may be grouped based upon any one or more of: company industry, geographic region of company, company size, company financial performance, or the like.

The data used to calculate the EETR may be automatically determined through member profile data of the social networking service. For example, users may list their current employer and title. The social networking service may sum a count of all the members who list the company as their current employer in their member profiles at the beginning of a particular time period and a count of all the members who list the company as their current employer in their member profiles at the end of a particular time period and divide that by two to get N. In other examples, snapshots of the social graph data of a company may be utilized to calculate employee turnover. For example, employees and employers may be nodes in a social graph connected by edges. The edges may be labelled as an employee-employer relationship. Changes in the social graph that are labelled as employee-employer relationships may allow the social networking service to determine EETR.

Employees who are members may be automatically categorized according to their seniority levels. This categorization may be based upon a predetermined mapping between particular job titles, as listed in the member's profile, and seniority levels. For example, a software engineer may be mapped to an entry level position whereas a senior software engineer may be mapped to a mid-level position. In other examples, the mapping may be done based upon the employee's experience level. For example, employees with less than 5 years experience (as based upon social networking member profile data which may include temporal information about employment) may be determined to be entry level; employees with 5-10 years may be mid-level; employees with 10-20 years may be senior level; and so on. Once employees of the company are grouped into seniority levels, Aᵢ and Si can be calculated for each seniority level. EETR may then be calculated according to the aforementioned formula.

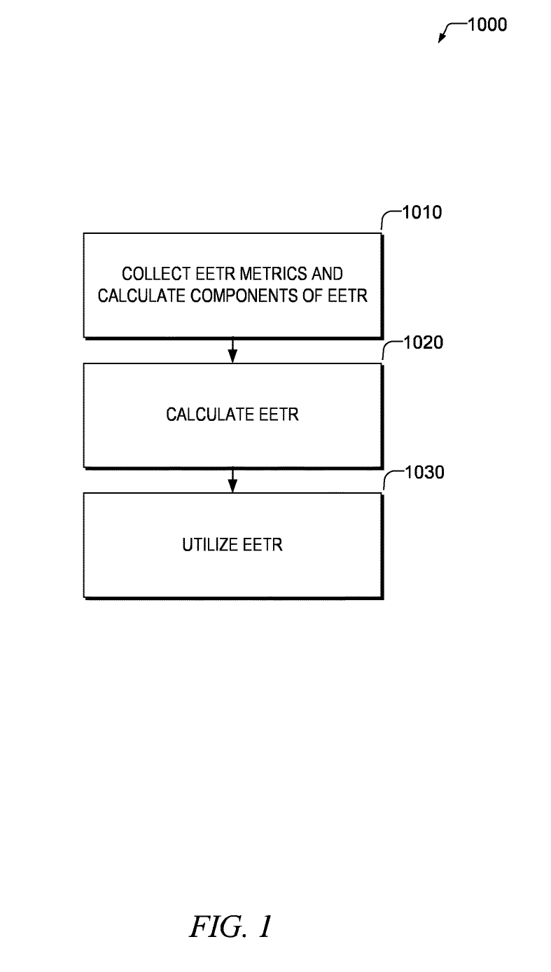

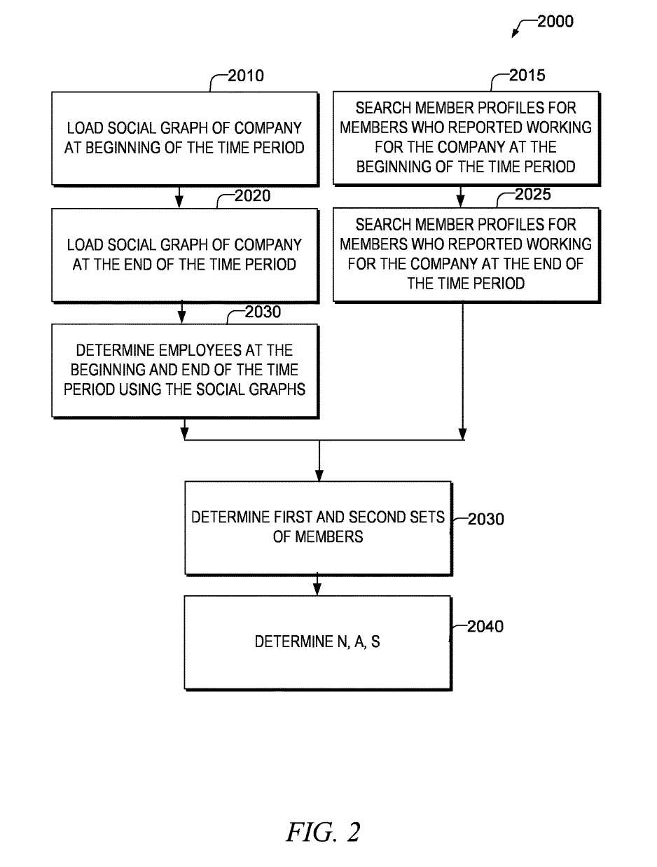

FIG. 1 is a flowchart of a method of providing an EETR to a member company of a social networking service according to some examples of the present disclosure. At operation 1010 the social networking service collects metrics for use in calculating the EETR and calculates component contributions of EETR (e.g., Aᵢ, Sᵢ, and N.) The metrics may be entered in manually by an employee of the company through a graphical user interface provided by the social networking service. In other examples, these metrics may be gathered from social networking data (e.g., profiles of members or the company). More details on how the data is gathered and the components are calculated is provided in FIG. 2 which will be discussed later.

The EETR is calculated at operation 1020 using the components and metrics from operation 1010. EETR may be calculated a number of ways. For example, the formula:

$$EETR = \frac{{\sum }_{i = 1}^{n} ( ln ( \frac{N}{{A}_{i}} ) * \frac{{S}_{i}}{{A}_{i}} )}{{\sum }_{i = 1}^{n} ln ( \frac{N}{{A}_{i}} )}$$

In other examples, other formulas may be utilized. For example, utilizing the classic turnover rate formula for each seniority level:

$$( \frac{NELDY}{( NEBY + NEEY ) \text{/} 2} ) * 100$$

And then combining each seniority level's turnover rate using a weighted sum where the weights sum to one.

At operation 1030, the EETR may be utilized. For example, the EETR may be communicated to the company, prospective employees, or other companies within the same industry (e.g., as part of a competitive analysis). This communication may be done through email, a graphical user interface provided by the social networking service, or the like.

FIG. 2 is a flowchart of example methods of collecting EETR metrics and calculating the components of the EETR according to some examples of the present disclosure. The social networking service may utilize operations 2010, 2020, and 2030 or alternatively 2015 and 2025 to obtain the metrics utilized to calculate the components of the EETR at operations 2030 and 2040.

In a first example, at operation 2010 the social networking service loads a social graph of a company at time A. At operation 2020 the social networking service loads a social graph of the company at time B. Time B and time A are separated by the amount of time in the given time period over which the EETR is calculated. The social graphs of a company at various times may be stored so as to allow for later retrieval of the social graph at a particular point in time to calculate EETR. At operation 2030 the social networking service may determine the employees at time A and B using the social graphs. A social graph may describe the connections between the company and other members of the social networking service. In some examples, the social graph is comprised of nodes (e.g., members and companies) and edges reflecting the relationships between nodes. Edges may be labeled based upon the type of relationship. In some examples, the edges may have a label that identifies members as employees of the company. Thus, examining the social graph of the company allows the social networking service to determine all members that are connected to the company with edges that identify that relationship as an employee/employer relationship.

Alternatively, at operation 2015, the social networking service may search its database of member profiles to find member profiles where the member reported in their profile that they worked for the company at the beginning of the time period. This may be done by archiving member profiles for later searching, or may be done utilizing dates of employment supplied by the member. At operation 2025 the social networking service may search its database of member profiles to find member profiles where the member reported in their profile that they worked for the company at the end of the time period.

Using the social networking data gathered at operations 2010-2030 or alternatively gathered at operations 2015 and 2025, a set of employees who worked for the company at the beginning of the time period and a second set of employees who worked for the company at the end of the time period are determined at operation 2030.

At operation 2040, the social networking service may calculate N, and may calculate Aᵢ and Sᵢ for all seniority levels i. The social networking service may count the number of members in the first set and in the second set. Using these counts, the average number of employees N may be calculated as the number of members of the first set plus the number of members of the second set divided by two. Additionally, the Aᵢ values for each seniority level are calculated by adding the number of members at each respective level in the first set to the number of employees at each respective level in the second set and dividing that sum by two. A member's level may be based upon a matching or similarity of the member's job title in their member profiles with a predetermined mapping of job titles to levels. An example predetermined mapping may look like:

| Job Title | n (seniority) level |
|---|---|
| Software engineer | 1 |
| Senior software engineer | 2 |
| Engineering manager | 3 |
| Director of Engineering | 4 |
| Vice President of Sales | 5 |
| Vice President of Marketing | 5 |
| Vice President of Engineering | 5 |
| Vice President of Accounting | 5 |
| CEO | 6 |
| CFO | 6 |
| COO | 6 |
| CIO | 6 |

Thus, for example, a member who lists “director of engineering” as their title may be assigned into the director level (n=4). These mappings may be predetermined by the social networking service, or may be input manually by an employee of the organization through a graphical user interface provided by the social networking service. Sᵢ values for each seniority level may also be calculated by utilizing member profile data to determine which members of the first set are no longer with the company for each seniority level.

In some examples, for a more meaningful interpretation of whether an EETR is good or bad, the social networking service may compute EETRs for many companies in the same industry. For example, companies on average in certain industries may have higher turnover than companies on average in other industries. The social networking service may present an average or median EETR for other companies in the same industry along with the EETR of the company. In other examples, other groups may be utilized (e.g., all companies in the S&P 500 for example). In some examples, the social networking service may compare the EETR of each seniority level to figure out for a given company, which seniority level has more liquidity than other levels and how that compares to an industry average.

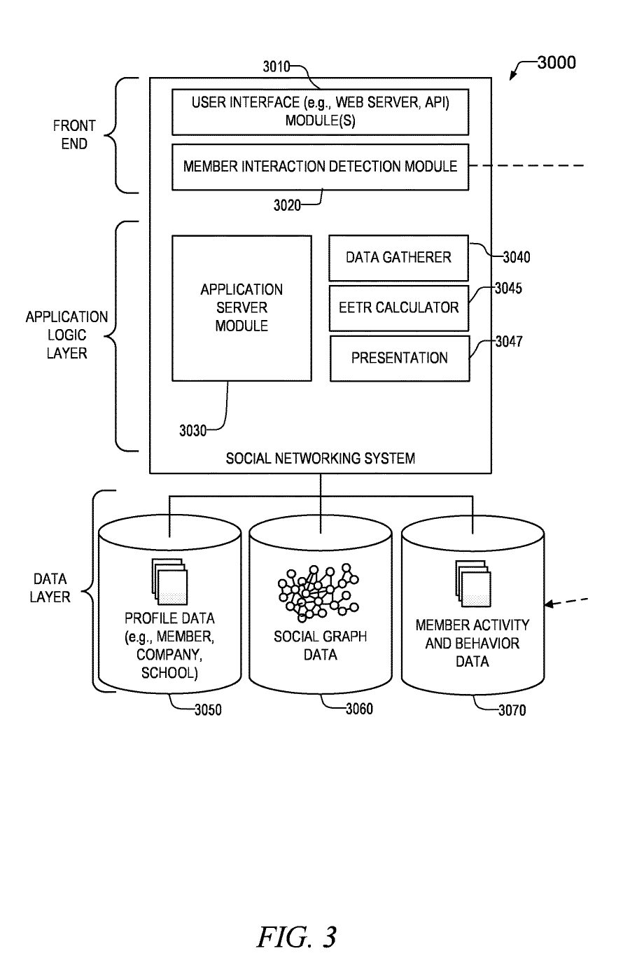

FIG. 3 is a block diagram showing the functional components of a social networking service 3000. As shown in FIG. 3, a front end may comprise a user interface module (e.g., a web server) 3010, which receives requests from various client-computing devices, and communicates appropriate responses to the requesting client devices. For example, the user interface module(s) 3010 may receive requests in the form of Hypertext Transport Protocol (HTTP) requests, or other network-based, application programming interface (API) requests (e.g., from a dedicated social networking service application running on a client device). In addition, a member interaction and detection module 3020 may be provided to detect various interactions that members have with different applications, services and content presented. As shown in FIG. 3, upon detecting a particular interaction, the member interaction and detection module 3020 logs the interaction, including the type of interaction and any meta-data relating to the interaction, in the member activity and behavior database 3070.

An application logic layer may include one or more various application server modules 3030, which, in conjunction with the user interface module(s) 3010, generate various graphical user interfaces (e.g., web pages) with data retrieved from various data sources in the data layer. With some embodiments, application server module 3030 is used to implement the functionality associated with various applications and/or services provided by the social networking service as discussed above.

Application layer may include a data gatherer module 3040 for gathering data and making preliminary calculations in order to calculate the EETR. The data gatherer module 3040 determines N, Aᵢ, and Sᵢ based upon user input or alternatively through analysis of member profile data stored in the profile data database 3050. Data gatherer module 3040 may execute instructions to cause a machine to perform the operations of FIG. 2. Application layer may also include EETR calculator 3045 that takes the data gathered by data gatherer module 3040 and inputs that data into the EETR algorithm which returns an EETR for a particular company over a particular time period. EETR calculator 3045 may calculate a number of EETR values for a number of companies and may calculate an average or median EETR values for a group of companies (e.g., all companies that are members of the social networking service, or a subset of all the companies such as an industry).

Presentation module 3047 may also be in the application logic layer and may work with the user interface module(s) 3010 to present the EETR to one or more members or users of the social networking service 3000. For example, the EETR may be presented on a company's profile page, a job search page, to a competitive intelligence report, and the like as a Graphical User Interface (GUI). The EETR may be stored in the profile data of the company in profile database 3050, or in other examples, in other data storage. In some examples, a company's EETR may be calculated when requested. In other examples, the company's EETR may be calculated on a periodic basis. The presentation module 3047 may also present as part of the GUI the median or average EETR of companies in a group of companies (e.g., an industry).

The social networking service 3000 may also include a database 3050 for storing profile data, including both member profile attributes as well as profile data for various organizations (e.g., companies, schools, etc.). Consistent with some embodiments, when a person initially registers to become a member of the social networking service 3000, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history (including job title, responsibilities, dates of employment, company name, and the like), skills, professional organizations, and so on. This information is stored, for example, in the profile database 3050. Similarly, when a representative of an organization initially registers the organization with the social networking service 3000, the representative may be prompted to provide certain information about the organization. This information may be stored, for example, in the database 3050, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Information describing the various associations and relationships, such as connections that the members establish with other members, or with other entities and objects are stored and maintained within a social graph in the social graph database 3060. Also, as members interact with the various applications, services and content made available via the social networking service, the members' interactions and behavior (e.g., content viewed, links or buttons selected, messages responded to, etc.) may be tracked and information concerning the member's activities and behavior may be logged or stored, for example, as indicated in FIG. 3 by the member activity and behavior database 3070.

With some embodiments, the social networking service 3000 provides an application programming interface (API) module with the User Interface module 3010 via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

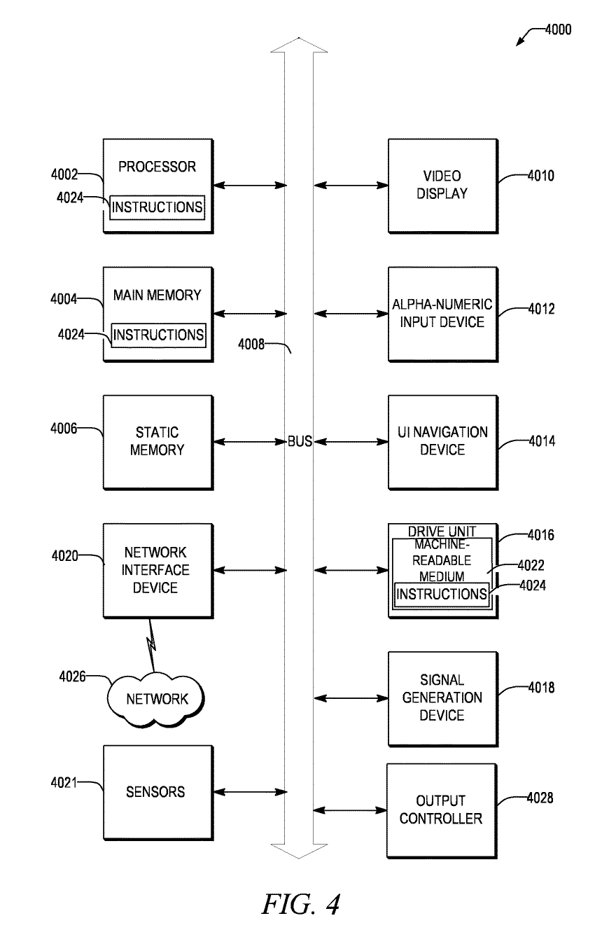

FIG. 4 illustrates a block diagram of an example machine 4000 upon which any one or more of the techniques (e.g., methodologies) discussed herein may perform. In alternative embodiments, the machine 4000 may operate as a standalone device or may be connected (e.g., networked) to other machines. In a networked deployment, the machine 4000 may operate in the capacity of a server machine, a client machine, or both in server-client network environments. In an example, the machine 4000 may act as a peer machine in peer-to-peer (P2P) (or other distributed) network environment. The machine 4000 may implement or include any portion of the social networking service 3000 from FIG. 3, and may take the form of a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 4000 may include a hardware processor 4002 (e.g., a central processing unit (CPU), a graphics processing unit (GPU), a hardware processor core, or any combination thereof), a main memory 4004 and a static memory 4006, some or all of which may communicate with each other via an interlink (e.g., bus) 4008. The machine 4000 may further include a display unit 4010, an alphanumeric input device 4012 (e.g., a keyboard), and a user interface (UI) navigation device 4014 (e.g., a mouse). In an example, the display unit 4010, input device 4012 and UI navigation device 4014 may be a touch screen display. The machine 4000 may additionally include a storage device (e.g., drive unit) 4016, a signal generation device 4018 (e.g., a speaker), a network interface device 4020, and one or more sensors 4021, such as a global positioning system (GPS) sensor, compass, accelerometer, or other sensor. The machine 4000 may include an output controller 4028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 4016 may include a machine readable medium 4022 on which is stored one or more sets of data structures or instructions 4024 (e.g., software) embodying or utilized by any one or more of the techniques or functions described herein. The instructions 4024 may also reside, completely or at least partially, within the main memory 4004, within static memory 4006, or within the hardware processor 4002 during execution thereof by the machine 4000. In an example, one or any combination of the hardware processor 4002, the main memory 4004, the static memory 4006, or the storage device 4016 may constitute machine readable media.

While the machine readable medium 4022 is illustrated as a single medium, the term “machine readable medium” may include a single medium or multiple media (e.g., a centralized or distributed database, and/or associated caches and servers) configured to store the one or more instructions 4024.

The term “machine readable medium” may include any medium that is capable of storing, encoding, or carrying instructions for execution by the machine 4000 and that cause the machine 4000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 4024 may further be transmitted or received over a communications network 4026 using a transmission medium via the network interface device 4020. The Machine 4000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 4020 may include one or more physical jacks (e.g., Ethernet, coaxial, or phone jacks) or one or more antennas to connect to the communications network 4026. In an example, the network interface device 4020 may include a plurality of antennas to wirelessly communicate using at least one of single-input multiple-output (SIMO), multiple-input multiple-output (MIMO), or multiple-input single-output (MISO) techniques. In some examples, the network interface device 4020 may wirelessly communicate using Multiple User MIMO techniques.

What is claimed is:

1. A method comprising:
determining, for a company, using social networking data of a social networking service, a first set of members who report working for the company at a first point in time and a second set of members who report working for the company at a second point in time;
calculating a turnover rate for the company based upon the first and second sets of members, the turnover rate that increases the turnover rate more for turnover associated with members who have high seniority than for turnover associated with less senior members; and
providing the turnover rate as part of a graphical user interface.

2. The method of claim 1, wherein determining the first set of members comprises:
retrieving a social graph of the company as of the first point in time.

3. The method of claim 1, wherein determining the first set of members comprises:
searching through member profiles for members who list the company on their member profiles as their employer as of the first point in time.

4. The method of claim 1, wherein calculating the turnover rate comprises:
calculating
$$\frac{{\sum }_{i = 1}^{n} ( ln ( \frac{N}{{A}_{i}} ) * \frac{{S}_{i}}{{A}_{i}} )}{{\sum }_{i = 1}^{n} ln ( \frac{N}{{A}_{i}} )}$$
where N is an average number of all employees between the first and second points in time, Aᵢ is a determined average number of employees for each i one of a plurality of seniority levels between the first and second points in time, Sᵢ is a determined total number of employees for each respective one of the plurality of seniority levels that discontinued working for the company between the first and second points in time, and n is the number of the plurality of seniority levels.

5. The method of claim 1 comprising:
calculating an average turnover rate for a plurality of other companies in a same industry as the company; and
presenting the average turnover rate along with the turnover rate as part of the graphical user interface.

6. The method of claim 1, wherein the graphical user interface is provided as part of a job posting by the company.

7. The method of claim 1, wherein the graphical user interface is provided on a company's profile page of the social networking service.

8. A non-transitory machine readable medium that stores instructions which when performed by a machine, cause the machine to perform operations comprising:
determining, for a company, using social networking data of a social networking service, a first set of members who report working for the company at a first point in time and a second set of members who report working for the company at a second point in time;
calculating a turnover rate for the company based upon the first and second sets of members, the turnover rate that increases the turnover rate more for turnover associated with members who have high seniority than for turnover associated with less senior members; and
providing the turnover rate as part of a graphical user interface.

9. The machine readable medium of claim 8, wherein the operations for determining the first set of members comprises:
retrieving a social graph of the company as of the first point in time.

10. The machine readable medium of claim 8, wherein the operations for determining the first set of members comprises:
searching through member profiles for members who list the company on their member profiles as their employer as of the first point in time.

11. The machine readable medium of claim 8, wherein the operations for calculating the turnover rate comprises:
calculating
$$\frac{{\sum }_{i = 1}^{n} ( ln ( \frac{N}{{A}_{i}} ) * \frac{{S}_{i}}{{A}_{i}} )}{{\sum }_{i = 1}^{n} ln ( \frac{N}{{A}_{i}} )}$$
where N is an average number of all employees between the first and second points in time, Aᵢ is a determined average number of employees for each i one of a plurality of seniority levels between the first and second points in time, Sᵢ is a determined total number of employees for each respective one of the plurality of seniority levels that discontinued working for the company between the first and second points in time, and n is the number of the plurality of seniority levels.

12. The machine readable medium of claim 8 wherein the operations comprise:
calculating an average turnover rate for a plurality of other companies in a same industry as the company; and
presenting the average turnover rate along with the turnover rate as part of the graphical user interface.

13. The machine readable medium of claim 8, wherein the graphical user interface is provided as part of a job posting by the company.

14. The machine readable medium of claim 8, wherein the graphical user interface is provided on a company's profile page of the social networking service.

15. A system comprising:
one or more computer processors;
a computer readable medium, communicatively coupled to the one or more processors, that stores instructions, which when performed by the one or more processors, cause the one or more processors to perform operations comprising:
determining, for a company, using social networking data of a social networking service, a first set of members who report working for the company at a first point in time and a second set of members who report working for the company at a second point in time;
calculating a turnover rate for the company based upon the first and second sets of members, the turnover rate that increases the turnover rate more for turnover associated with members who have high seniority than for turnover associated with less senior members; and
providing the turnover rate as part of a graphical user interface.

16. The system of claim 15, wherein the operations for determining the first set of members comprises:
retrieving a social graph of the company as of the first point in time.

17. The system of claim 15, wherein the operations for determining the first set of members comprises:
searching through member profiles for members who list the company on their member profiles as their employer as of the first point in time.

18. The system of claim 15, wherein the operations for calculating the turnover rate comprises:
calculating
$$\frac{{\sum }_{i = 1}^{n} ( ln ( \frac{N}{{A}_{i}} ) * \frac{{S}_{i}}{{A}_{i}} )}{{\sum }_{i = 1}^{n} ln ( \frac{N}{{A}_{i}} )}$$
where N is an average number of all employees between the first and second points in time, Aᵢ is a determined average number of employees for each i one of a plurality of seniority levels between the first and second points in time, Sᵢ is a determined total number of employees for each respective one of the plurality of seniority levels that discontinued working for the company between the first and second points in time, and n is the number of the plurality of seniority levels.

19. The system of claim 15, wherein the operations comprise:
calculating an average turnover rate for a plurality of other companies in a same industry as the company; and
presenting the average turnover rate along with the turnover rate as part of the graphical user interface.

20. The system of claim 15, wherein the graphical user interface is provided as part of a job posting by the company.

21. The system of claim 15, wherein the graphical user interface is provided on a company's profile page of the social networking service.
